(19) United States
(12) Patent Application Publication
(10) Pub. No.: US 2025/0140816 A1
(43) Pub. Date: May 1, 2025

(54) SINGLE-LAYER ANODE

(71) Applicant: NORTHVOLT AB, Stockholm (SE)

(72) Inventors: Hwamyung JANG, Stockholm (SE); Léo DUCHÊNE, Västerås (SE)

(21) Appl. No.: 18/836,572

(22) PCT Filed: Feb. 16, 2023
(86) PCT No.: PCT/EP2023/053917

§ 371 Date: Aug. 7, 2024

(30) Foreign Application Priority Data
Feb. 16, 2022 (SE) 2250158-9

(51) Int. Cl. H01M 4/38; H01M 4/02; H01M 4/133; H01M 4/134; H01M 4/36; H01M 4/583; H01M 10/052; H01M 10/0568; H01M 10/0569

(52) U.S. Cl. CPC H01M 4/382; H01M 4/133; H01M 4/134; H01M 4/366; H01M 4/583; H01M 10/052; H01M 10/0568; H01M 10/0569; H01M 2004/021; H01M 2004/027; H01M 2220/20

(57) ABSTRACT

The invention relates to a secondary cell comprising an anode, a cathode, optionally a separator, and an electrolyte, characterized in that the anode comprises an active material or composition of active materials, wherein at least one active material or composition of active materials functions as a current collector, wherein the active material or composition of active materials comprises carbon, silicon, and/or metal oxide(s), and wherein the anode does not comprise any additional current collector. A vehicle comprising said secondary cell is also claimed.

### FIELD OF INVENTION

The present invention relates to a porous electrode for a secondary cell. More particularly, the present invention relates to a secondary cell including single-layer anode, as well as a vehicle comprising such secondary cell.

### BACKGROUND

Rechargeable batteries having high energy density and discharge voltage, in particular Li-ion batteries, are an important component in portable electronic devices and are a key enabler for the electrification of transport and large-scale storage of electricity.

To reach high energy densities, new types of secondary cells are being developed.

State of the art Li-ion batteries typically consists of stacks of secondary cells, wherein each cell is composed of a cathode comprising a cathode current collector, an electrolyte, an anode comprising an anode current collector, and optionally a separator positioned between the anode and cathode.

The current collector bring and/or collect the electronic current during charge and discharge, respectively, connecting the electrodes with an external circuit. Such current collectors do not actively store ions and thus add to the weight of secondary cells, and makes manufacture thereof cumbersome by adding additional manufacturing steps such as coating of the active material onto said current collector. Hence, there is a need for more weight and volume efficient secondary cells.

### SUMMARY OF THE INVENTION

An object of the present invention is to provide a single-layer anode for a secondary cell, enabling a reduction in weight and volume.

### BRIEF DESCRIPTION OF THE DRAWINGS

FIG. 1 shows the N/P ratio in relation to the porosity.

FIG. 2 shows the thinness of the single-layer anode without current collector foil.

FIG. 3 shows a single-layer anode notched into the appropriate shape for subsequent pouch cell testing.

FIG. 4 shows a top-view micrograph image of a single-layer anode comprising of fibre-like graphitic material.

FIG. 5 shows a 2^{nd} cycle charge and discharge curve of a single layer anode under galvanostatic cycling conditions.

FIG. 6 shows the Coulombic Efficiency for lithiation and plating, and de-lithiation and stripping, for a single-layer anode compared with a standard graphite electrode, coated on a copper current collector.

FIG. 7 shows a top-view micrograph image of lithium plated on a single-layer graphite anode after 20 cycles of lithiation and plating, and de-lithiation and stripping.

### DESCRIPTION OF THE INVENTION

A first aspect of the invention relates to a secondary cell comprising an anode, a cathode, optionally a separator, and an electrolyte, characterized in that the anode comprises an active material or composition of active materials, wherein at least one active material or composition of active materials functions as a current collector, wherein the active material or the composition of active materials comprises carbon, silicon, and/or metal oxide(s), and wherein the anode does not comprise any additional current collector. Removing the current collector is thus a way to reduce the battery weight and increase its energy density as well as to reduce the number of manufacturing steps.

The embodiments and aspects disclosed throughout this description may be combined in any combination(s). Making such combinations is well within the abilities of the person skilled in the art.

As used herein, active material or composition of active materials means any material or composition having electronically conductive properties, while at the same time facilitating lithiation and/or plating.

In one embodiment, the anode constitutes one layer. This would simplify the manufacture of a secondary cell.

In one embodiment, the active material or composition of active materials comprises or constitutes particles.

In one embodiment, the active material or composition of active materials is selected from the group consisting of carbon, silicon, and/or metal oxide(s). Preferably, the active material or composition of active materials is a fiber-containing graphitic material. An example thereof is shown in FIG. 4.

In a further embodiment, the anode of the secondary cell does not comprise any metal foil, metal mesh, or metal fibers.

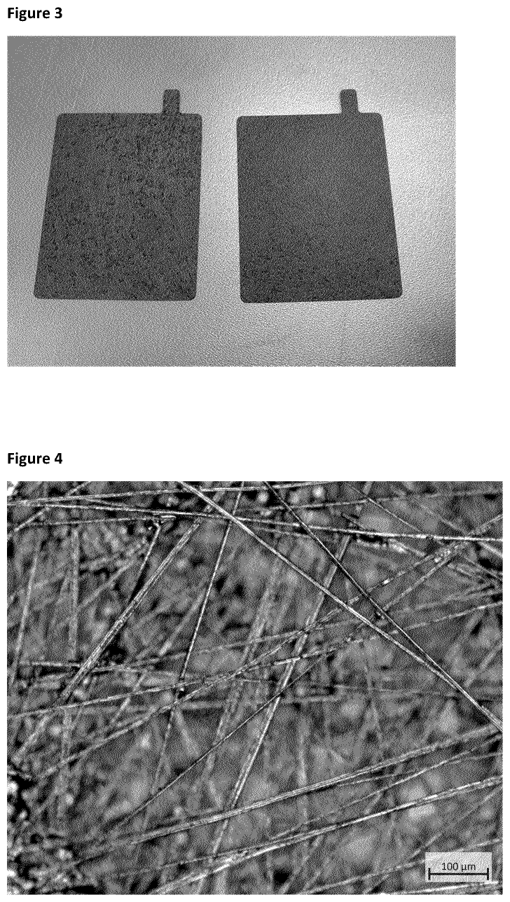

Combining the active material and the current collector into one single structure allows for large cost savings by simplifying the manufacturing process of the anode. This circumvents the need for a separate current collector. For example, avoiding the use of metal foil, metal mesh, or metal fibers effectively contributes to reducing the number of manufacturing steps. Moreover, the compact structure obtained allows for increased energy densities, at lower battery volumes. Despite the absence of a current collector, the Coulombic Efficiency (CE) over repeated cycles is maintained or even improved (see FIG. 6). FIGS. 2 and 3 show examples of single layered anodes of the invention.

In one embodiment, the active material or composition of active materials comprises lithium. This is achieved by pre-lithiation of the secondary cell, whereby the active material or composition of active materials has been treated with lithium or lithium ions physically or electrochemically in order to incorporate a certain amount of lithium or lithium ions into the material before the first charging cycle. By incorporating lithium into the material, it is possible to reduce the impact of the irreversible electrochemical losses during the first instances of charging. The amount of incorporated lithium could be adjusted to be at or below the amount corresponding to these irreversible electrochemical losses. The level of lithium incorporation into the material can be adjusted according to preference. The skilled person is well equipped to conduct such adjustments.

In one embodiment the active material or composition of active materials comprises particles which are at least partially pre-lithiated.

Pre-lithiation of the anode will increase the total lithium content in the cell, which can compensate for lost lithium ion during operation, and improve the total cycle life of the battery.

In one embodiment the active material or composition of active materials is saturated with lithium. Suitable compounds for such saturation are for example Li₁₅Si₄, LiC₆, Li₁₃Sn₅, and Li₉Al₄.

In one embodiment the secondary cell is a lithium secondary cell.

In yet one embodiment, the active material or composition of active materials comprises non-graphitizing carbon, carbon paper, interwoven carbon, carbon nanotubes (CNT), graphite, silicon, silicon oxide (SiOₓ, x smaller than or equal to 2), silicon alloy, silicon-carbon composite, a transition metal dichalcogenide (e.g. titanium disulfide (TiS₂)), tin-cobalt alloy, lithium titanate oxide (LTO, Li₄Ti₅O₁₂), and MXenes (two-dimensional transition metal carbides, carbonitrides and nitrides, e.g. V₂CTₓ, Nb₂CTₓ, Ti₂CTₓ, and Ti₃C₂Tₓ), or a combination of at least two of these.

The term “MXenes”, as used herein, represents two-dimensional inorganic compounds making up a-few-atoms-thick layers of transition metal carbides, nitrides, or carbonitrides. MXenes combine the metallic conductivity of transition metal carbides with a hydrophilic character.

In yet another embodiment, the anode has a porosity in the interval of from 10% to 90% of the total volume of the material, preferably from 15% to 75%, more preferably from 25 to 50%. In a preferred porosity interval of from 10% to 30%, lithiation of lithium ions into the active material or composition of active materials is facilitated. In another preferred porosity interval of from 30% to 70%, or from 30% to 60%, plating of lithium metal onto the active material or composition of active materials is facilitated. After lithiation, lithium ions are stored within the anode material or composition of active materials without occupying any of the void volume constituting the pores. Whereas, in accordance with the invention, the lithium plating takes place on the surface of the pores of the active material or composition of active materials, effectively filling the void volume without causing any substantial volume change of the anode. This is especially important during repeated charging cycles. The present invention improves the cycling stability and reduces the risk for early secondary cell failure, both under normal and high current operations.

During continuous cycling, plating of the anode at the top layer may result in unfavorable dendritic growth of lithium metal. To prevent dendritic growth, the interfacial activity of the top surface is reduced in accordance with the invention, whereby lithium ion reduction on the top surface is reduced, while at the same time lithium-ions are allowed to migrate deep into the anode. As a result, lithium metal starts to deposit bottom-up in the anode, gradually filling the void spaces.

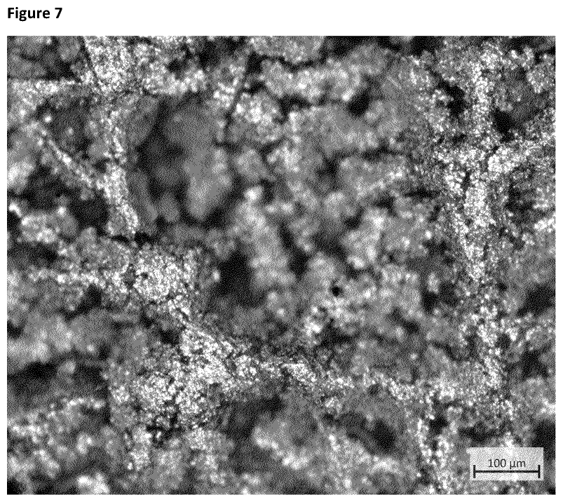

The void space is, in accordance with the present invention, large enough to accommodate the total volume of plated lithium. Hence, the porosity of the layer can be optimized through the choice of active material or composition of active materials, as well as the ratio between lithiated lithium ions and plated lithium metal. The skilled person is well equipped to make such an optimization. By adjusting the porosity, the ratio between lithiated lithium-ions and plated lithium metal may be optimized such that the plated lithium can be contained within the porosity of the lithium-ion storage layer rather than being plated on top of the layer surface. The skilled person is well equipped to make such an optimization. An example of a lithium plated on a single-layer graphite anode after 20 cycles is presented in FIG. 7. The variation in optical focus shows the plated lithium at different depths of the material, indicating that lithium plating is not confined only to the top surface of the active material or composition of active materials.

The minimum porosity of the anode may be calculated according to formula (1) as shown below.

$$P = \frac{( 1 - r ) {C}_{a} \cdot {ρ}_{a}}{r \cdot {C}_{a} \cdot {ρ}_{a} + ( 1 - r ) {C}_{Li} \cdot {ρ}_{Li}} \qquad ( 1 )$$

wherein P is the porosity, r is the N/P ratio, Cₐ is the anode specific capacity, or in the case of a composition of active materials the weighted average anode specific capacity, [mAh/g], ρₐ is the anode active material density, or in the case of a composition of active materials the weighted average anode active material density [g/cm³], C_{Li} is the lithium capacity [mAh/g](3862 mAh/g), and ρ_{Li} is the lithium density [g/cm³](0.53 g/cm³). The term “N/P ratio” is used herein for the capacity ratio between the anode (the negative electrode) and cathode (the positive electrode).

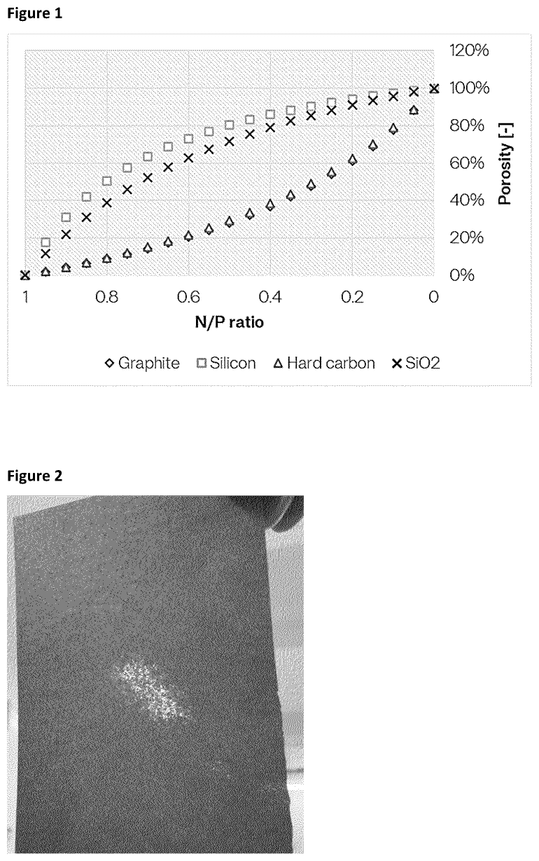

Finding the anode specific capacity for the anode material and lithium specific capacity is common knowledge in the field. FIG. 1 shows the relation between the porosity, P, for a selection of active materials and the N/P ratio. By undersizing the anode lithium-ion storage capacity with regards to the cathode capacity, such that some of the lithium will be stored in the anode as lithium metal, the energy density can be increased. Since the anode layer of the invention is porous, the lithium metal may be contained within the pores, thus reducing dendrite formation and issues of volume changes that are common pitfalls for lithium metal batteries.

In one embodiment the anode_loading amount to the cathode_loading amount (N/P ratio) is 0.01 to 0.99, preferably 0.25 to 0.75, more preferably 0.3 to 0.5.

In one embodiment the anode has a porosity in the range of P to 1.25*P, where P is defined as the porosity according to formula (1).

In one embodiment, the anode comprises at least two anode layers, at least one anode layer comprising an active material or composition of active materials, wherein at least one active material or a composition of active materials functions as a current collector, and wherein the layers have different exchange current densities of lithium plating. Using at least one anode according to the invention, the volume of the secondary cell may be reduced.

In one embodiment, the anode layer closest to the separator has a surface with lower exchange current density of lithium plating compared to the other anode layer(s). The plating starts closest to the incoming current during charging. This results in lithium plating “bottom up”, which maximizes the plating capacity by reducing non-plated voids.

In one embodiment, a functional layer is at least partially coated on the particles of the active material or composition of active materials. Preferably, the functional layer comprises a surface functional group, for example, OH, COOH, CSOH, CONH₂, CSNH₂, NH, NH₂, SH, CN, NO₂ and triazolium; non-graphitizing carbon; a metal or metalloid, for example Si, Sn, Al, Zn, Ag, In, Mg; a metal or metalloid oxide, for example, Al₂O₃, LiAlO₂, ZnO, MnO₂, Co₃O₄, SnO₂, SiOₓ (x smaller than or equal to 2), V₂O₅, CuₓO (1≤x≤2), TiO₂, Li₂O, Li₂O₂, ZrO₂, MgO, Ta₂O₅, Nb₂O₅, LiAlO₂, Li₇La₃Zr₂O₁₂ (LLZO), Li₄Ti₅O₁₂ (LTO), B₂O₃, Li₃BO₃—Li₂CO₃; a metal fluoride, for example AlF₃, LiF; a metal phosphate, for example AlPO₄, Li₃PO₄, Li_{1.3}Al_{0.3}Ti_{1.7}(PO₄)₃(LATP); piezoelectric material, such as BaTiO₃, PbZrₓTi₁₋ₓO₃ where x is any number between 1 and 10; a metal hydroxide, such as AlO(OH) (boehmite), Mg(OH)₂, Al(OH)₃; a metal or metalloid nitride, such as AlN, BN, Si₃N₄; Al(NO₃)₃; BaSO₄; or a polymer or polymer electrolyte, containing for example polyvinylidene fluoride (PVDF), preferably in its beta phase, PVDF-HFP, PMMA, PEO, polysiloxane for example PDMS, lithium polyacrylate (Li-PAA); and mixtures thereof.

In the embodiment wherein the electrolyte is a liquid electrolyte, said liquid electrolyte comprises at least one lithium salt and at least one or more solvents selected from the group consisting of carbonate solvents and their fluorinated equivalents, diC₁₋₄ ethers and their fluorinated equivalents and ionic liquids.

The lithium salt is one or more lithium salts selected from the group consisting of lithium hexafluorophosphate (LiPF₆), lithium bis(fluorosulfonyl)imide (LiFSI), lithium bis(trifluoromethanesulfonyl)imide (LiTFSI), lithium (fluorosulfonyl) (trifluoromethanesulfonyl)imide (LiFTFSI), lithium bis(pentafluoroethanesulfonyl)imide (LiBETI), lithium (pentafluoroethanesulfonyl)(trifluoromethanesulfonyl)imide (LiPTFSI), lithium trifluoromethanesulfonate (LiOTf), lithium bis(oxalato)borate (LiBOB), lithium difluoro(oxalato)borate (LiDFOB), lithium difluorobis(oxalato)phosphate (LiDFOP), lithium tetrafluoro(oxalato)phosphate (LiTFOP), lithium tetrafluoroborate (LiBF₄), lithium nitrate (LiNO₃) lithium 2-trifluoromethyl-4,5-dicyanoimidazole (LiTDI).

The solvent is selected from the group consisting of 1,2-dimethoxyethane (DME), N-propyl-N-methylpyrrolidinium bis(fluorosulfonyl)imide (PYR13-FSI), N-propyl-N-methylpyrrolidinium bis(trifluoromethanesulfonyl)imide (PYR13-TFSI), 1-butyl-1-methylpyrrolidinium bis(fluorosulfonyl)imide (PYR14-FSI), 1-butyl-1-methylpyrrolidinium bis(trifluoromethanesulfonyl)imide (PYR14-TFSI), 1-ethyl-3-methylimidazolium bis(fluorosulfonyl)imide (EMIM-FSI), 1-ethyl-3-methylimidazolium bis(trifluoromethanesulfonyl)imide (EMIM-TFSI), dimethyl carbonate (DMC), ethyl methyl carbonate (EMC), diethyl carbonate (DEC), ethylene carbonate (EC), and propylene carbonate (PC), and their fluorinated equivalents.

In the embodiment wherein the electrolyte is a solid electrolyte, said solid electrolyte comprising Li₂S—P₂S₅; Li₃PS₄; Li₇P₃S₁₁; LLZO-based materials for example Li₇La₃Zr₂O₁₂, Li_{6.24}La₃Zr₂Al_{0.24}O_{11.98}, and Li_{6.4}La₃Zr_{1.4}Ta_{0.6}O₁₂; Li_{0.34}La_{0.56}TiO₃ (LLTO); Li_{1.3}Al_{0.3}Ti_{1.7}(PO₄)₃(LATP); thio-LISICON for example Li₁₀MP₂X₁₂ (M=Si or Ge; X=S or Se), lithium argyrodite Li_{6+y}M_{y}^{IV}M_{1-y}^{V}S₅X (X=Cl, Br, or I; M^{IV} is a group IV element for example Si, Ge, or Sn; Mv is a group V element for example P or Sb; and 0≤y≤1); polymer-based solid electrolytes, for example PEO-LiTFSI mixtures; lithium hydrido-borates LiₓB_{y}H_{z} (x=1 or 2, 1≤y≤12, 4≤z≤14); and lithium hydrido-carba-borates LiCₓB_{y}H_{z} (x=1 or 2, 9≤y≤11, 12≤z≤14).

In one aspect of the invention, a vehicle comprising a secondary cell as herein described is disclosed.

### EXAMPLES

### Example 1—Charge and Discharge Curve of a Single-Layer Anode

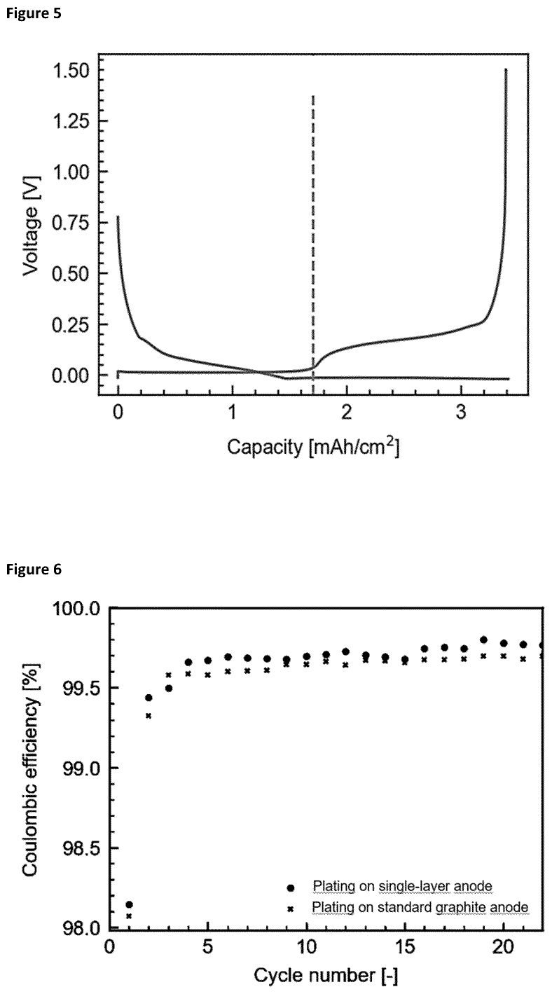

A single-layer anode, composed of 100% graphite with a reversible intercalation capacity of ca 275 mAh/g and a porosity of ca 70%, giving an area intercalation capacity of ca 1.7 mAh/cm², was used. A two-electrode half-cell experiment was conducted with the above-mentioned anode as the working electrode and lithium metal in large excess as the counter electrode. The electrolyte used in the experiment was composed of LiFSI:dimethoxyethane (DME):1,1,2,2-Tetrafluoroethyl 2,2,3,3-Tetrafluoropropyl Ether (TTE) in a 1:1.2:3 molar ratio. The electrode was charged to 3.4 mAh/cm², providing a deposition of 1.7 mAh/cm² of lithium metal, corresponding to a N/P ratio of 0.5. The charge and discharge curve of the second cycle under galvanostatic cycling conditions is shown in FIG. 5. The vertical dashed line highlights the transition from lithiation and de-lithiation to plating and stripping.

### Example 2—CE Comparison

A comparison of Coulombic Efficiency for the lithiation and plating, and de-lithiation and stripping process was made between a single-layer anode (same electrode as in Example 1) and a standard graphite electrode coated on a copper current collector. For both electrodes, the total capacity was close to 4 mAh/cm², of which half was in the form of lithium metal. The electrolyte used was the same as in Example 1. The result, shown in FIG. 6, shows that CE for the lithiation and plating, and de-lithiation and stripping process for a single-layer anode is slightly higher than for a standard graphite anode. This proves that a separate current collector, e.g. in the form of a foil, is not necessary for efficient lithium metal plating in a single-layer anode cell. FIG. 7 shows a top-view micrograph of lithium plated on the single-layer anode after 20 cycles. The difference in optical focus shows that the lithium plating occurs at different depths within the porous electrode, due to the open porosity of the electrode. The image of FIG. 7 was acquired using a Zeiss Axio Imager M2m microscope with a 10× magnification. To prevent any reaction of lithium-metal with air, the sample was sealed under argon in a dedicated cell with a transparent window.

1-21. (canceled)

22. A secondary cell comprising an anode, a cathode, optionally a separator, and an electrolyte, characterized in that the anode comprises particles of an active material or a composition of active materials, wherein at least one active material or composition of active materials functions as a current collector, wherein the active material or the composition of active materials comprises carbon, silicon, and/or metal oxide(s), and wherein the anode does not comprise any additional current collector.

23. The secondary cell according to claim 22, wherein the active material or composition of active materials comprises or constitutes particles.

24. The secondary cell according to claim 22, wherein the active material or composition of active materials is selected from the group consisting of carbon, silicon, and/or metal oxide(s).

25. The secondary cell according to claim 22, wherein the anode does not comprise any metal foil, metal mesh, or metal fibers.

26. The secondary cell according to claim 22, wherein the active material or composition of active materials comprises metallic lithium.

27. The secondary cell according to claim 22, wherein the active material or composition of active materials comprises non-graphitizing carbon, carbon paper, interwoven carbon, carbon nanotubes (CNT), graphite, silicon, silicon alloy, silicon oxide (SiOₓ, x smaller than or equal to 2), silicon-carbon composite, a transition metal dichalcogenide (e.g. titanium disulfide (TiS₂)), tin-cobalt alloy, lithium titanate oxide (LTO, Li₄T₁₅O₁₂), and MXenes (e.g. V₂CTₓ, Nb₂CTₓ, Ti₂CTₓ, and Ti₃C₂Tₓ), or a combination of at least two of these.

28. The secondary cell according to claim 22, wherein the active material or composition of active materials comprises particles which are at least partially pre-lithiated.

29. The secondary cell according to claim 22, wherein the active material or composition of active materials comprises Li₁₅Si₄, LiC₆, Li₁₃Sn₅, or Li₉Al₄.

30. The secondary cell according to claim 22, wherein the anode has a porosity in the interval of from 10% to 90% of the total volume of the anode, preferably from 15% to 75%, more preferably from 25 to 50%.

31. The secondary cell according to claim 22, wherein the anode has a minimum porosity as defined by formula (1):
$$P = \frac{( 1 - r ) {C}_{a} \cdot {ρ}_{a}}{r \cdot {C}_{a} \cdot {ρ}_{a} + ( 1 - r ) {C}_{Li} \cdot {ρ}_{Li}} \qquad ( 1 )$$
wherein P is the porosity, r is the N/P ratio, Cₐ is the anode specific capacity, or in the case of a composition of active materials the weighted average anode specific capacity, [mAh/g], ρₐ is the anode active material density, or in the case of a composition of active materials the weighted average anode active material density [g/cm³], C_{Li} is the lithium capacity [mAh/g], and ρ_{Li} is the lithium density [g/cm³].

32. The secondary cell according to claim 31, wherein the anode has a porosity in the range of P to 1.25*P, where P is defined as the porosity according to formula (1).

33. The secondary cell according to claim 22, wherein the anode constitutes one layer.

34. The secondary cell according to claim 22, wherein the anode comprises at least two anode layers, at least one anode layer comprising an active electrode material or composition of active materials, wherein at least one active material or composition of active materials functions as a current collector, and wherein the layers have different exchange current densities of lithium plating.

35. The secondary cell according to claim 22, wherein the anode layer closest to the separator has a surface with lower exchange current density of lithium plating compared to the other anode layer(s).

36. The secondary cell according to claim 22, wherein a functional layer is at least partially coated on the particles of the active material or composition of active materials.

37. The secondary cell according to claim 36, wherein the functional layer comprises surface functional group, for example, OH, COOH, CSOH, CONH₂, CSNH₂, NH, NH₂, SH, CN, NO₂ and triazolium; non-graphitizing carbon; a metal or metalloid, for example Si, Sn, Al, Zn, Ag, In, Mg; a metal or metalloid oxide, for example, Al₂O₃, LiAlO₂, ZnO, MnO₂, Co₃O₄, SnO₂, SiOₓ (x smaller than or equal to 2), V₂O₅, CuₓO (1≤x≤2), TiO₂, Li₂O, Li₂O₂, ZrO₂, MgO, Ta₂O₅, Nb₂O₅, LiAlO₂, Li₇La₃Zr₂O₁₂ (LLZO), Li₄Ti₅O₁₂ (LTO), B₂O₃, Li₃BO₃—Li₂CO₃; a metal fluoride, for example AlF₃, LiF; a metal phosphate, for example AlPO₄, Li₃PO₄, Li_{1.3}Al_{0.3}Ti_{1.7}(PO₄)₃ (LATP); piezoelectric material, such as BaTiO₃, PbZrₓTi₁₋ₓO₃ where x is any number between 1 and 10; a metal hydroxide, such as AlO(OH) (boehmite), Mg(OH)₂, Al(OH)₃; a metal or metalloid nitride, such as AlN, BN, Si₃N₄; Al(NO₃)₃; BaSO₄; or a polymer or polymer electrolyte, containing for example polyvinylidene fluoride (PVDF), preferably in its beta phase, PVDF-HFP, PMMA, PEO, polysiloxane for example PDMS, lithium polyacrylate (Li-PAA); and mixtures thereof.

38. The secondary cell according to claim 22, wherein the electrolyte is a liquid electrolyte comprising at least one lithium salt and at least one or more solvents selected from the group consisting of carbonate solvents and their fluorinated equivalents, diC₁₋₄ ethers and their fluorinated equivalents and ionic liquids.

39. The secondary cell according to claim 38, wherein the lithium salt is one or more selected from the group consisting of lithium hexafluorophosphate (LiPF₆), lithium bis(fluorosulfonyl)imide (LiFSI), lithium bis(trifluoromethanesulfonyl)imide (LiTFSI), lithium (fluorosulfonyl) (trifluoromethanesulfonyl)imide (LiFTFSI), lithium bis(pentafluoroethanesulfonyl)imide (LiBETI), lithium (pentafluoroethanesulfonyl)(trifluoromethanesulfonyl)imide (LiPTFSI), lithium trifluoromethanesulfonate (LiOTf), lithium bis(oxalato)borate (LiBOB), lithium difluoro(oxalato)borate (LiDFOB), lithium difluorobis(oxalato)phosphate (LiDFOP), lithium tetrafluoro(oxalato)phosphate (LiTFOP), lithium tetrafluoroborate (LiBF₄), lithium nitrate (LiNO₃) lithium 2-trifluoromethyl-4,5-dicyanoimidazole (LiTDI).

40. The secondary cell according to claim 38, wherein the solvent is selected from the group consisting of 1,2-dimethoxyethane (DME), N-propyl-N-methylpyrrolidinium bis(fluorosulfonyl)imide (PYR13-FSI), N-propyl-N-methylpyrrolidinium bis(trifluoromethanesulfonyl)imide (PYR13-TFSI), 1-butyl-1-methylpyrrolidinium bis(fluorosulfonyl)imide (PYR14-FSI), 1-butyl-1-methylpyrrolidinium bis(trifluoromethanesulfonyl)imide (PYR14-TFSI), 1-ethyl-3-methylimidazolium bis(fluorosulfonyl)imide (EMIM-FSI), 1-ethyl-3-methylimidazolium bis(trifluoromethanesulfonyl)imide (EMIM-TFSI), dimethyl carbonate (DMC), ethyl methyl carbonate (EMC), diethyl carbonate (DEC), ethylene carbonate (EC), and propylene carbonate (PC), and their fluorinated equivalents.

41. The secondary cell according to claim 22, wherein the electrolyte is a solid electrolyte comprising Li₂S—P₂S₅; Li₃PS₄; Li₇P₃S₁₁; LLZO-based materials, for example Li₇La₃Zr₂O₁₂, Li_{6.24}La₃Zr₂Al_{0.24}O_{11.98}, Li_{6.4}La₃Zr_{1.4}Ta_{0.6}O₁₂; Li_{0.34}La_{0.56}TiO₃ (LLTO); Li_{1.3}Al_{0.3}Ti_{1.7}(PO₄)₃ (LATP); thio-LISICON, for example Li₁₀MP₂X₁₂ (M=Si or Ge; X=S or Se), lithium argyrodite Li_{6+y}M_{y}^{IV}M_{1-y}^{V}S₅X (X=Cl, Br, or I; M^{IV} is a group IV element for example Si, Ge, or Sn; Mv is a group V element for example P or Sb; and 0≤y≤1), polymer-based solid electrolytes, for example PEO-LiTFSI mixtures; lithium hydrido-borates LiₓB_{y}H_{z} (x=1 or 2, 1≤y≤12, 4≤z≤14); and lithium hydrido-carba-borates LiCₓB_{y}H_{z} (x=1 or 2, 9≤y≤11, 12≤z≤14).

42. Vehicle comprising the secondary cell according to claim 22.
